(19) United States
(12) Patent Application Publication
(10) Pub. No.: US 2009/0068090 A1
(43) Pub. Date: Mar. 12, 2009

(54) METHODS FOR REACTING AND SEPARATING COMPONENTS OF A GAS-PHASE EQUILIBRIUM REACTION AND A CENTRIFUGAL SEPARATION DEVICE FOR SAME

(75) Inventor: ROBERT S. CHERRY, IDAHO FALLS, ID (US)

Correspondence Address: BATTELLE ENERGY ALLIANCE, LLC, P.O. BOX 1625, IDAHO FALLS, ID, 83415-3899, US

(73) Assignee: BATTELLE ENERGY ALLIANCE, LLC, IDAHO FALLS, ID (US)

(21) Appl. No.: 11/850,843

(22) Filed: Sep. 6, 2007

(51) Int. Cl. C01B 3/06; C01B 3/02; B01J 8/00

(52) U.S. Cl. 423/658.2; 423/648.1; 422/187

(57) ABSTRACT

A method of separating gaseous components. An equilibrium-limited, gas phase reaction is conducted in a centrifugal separation device and at least a portion of a first product of the reaction is separated from a reaction mixture comprising at least one reactant and at least one product in the centrifugal separation device. In another embodiment, the equilibrium-limited, gas phase reaction is conducted in a reactor and a reaction mixture is transferred from the reactor to the centrifugal separation device for separation of at least a portion of the first product. A gas centrifuge comprising at least one rotor and a catalyst is disclosed, as is a gas cyclone comprising the catalyst. The catalyst is formulated to increase a rate of the equilibrium-limited, gas phase reaction.

### GOVERNMENT RIGHTS

The United States Government has certain rights in this invention pursuant to Contract No. DE-AC07-05-ID14517, between the United States Department of Energy and Battelle Energy Alliance, LLC.

### FIELD OF THE INVENTION

The present invention relates to separation of gases. More specifically, the present invention relates to reacting and separating gaseous components using a centrifugal separation device.

### BACKGROUND

Gas centrifuges are known in the art and have been used for separating gaseous radioactive isotopes, such as for uranium enrichment. Gas centrifuges have also been used to separate gases having different chemical compositions and molecular weights. As described in U.S. Pat. No. 6,716,269 to Graff et al., a gas centrifuge is used to separate impurities, such as carbon dioxide, from natural gas. Fluid centrifuge devices, such as gas centrifuges, have been used to separate fluids and solids, as described in U.S. Pat. No. 5,554,343 to Wade. The gas centrifuge is used to separate particulate matter from diesel engine exhaust and to separate sulfur-containing compounds from the diesel engine exhaust. The gas centrifuge is coated with a catalyst to promote the formation of particulate matter from the diesel engine exhaust.

U.S. Pat. No. 4,092,130 to Wikdahl describes separating gaseous components by producing a cone shaped vortex in a cyclone. The cyclone is used to separate carbon dioxide from air or carbon dioxide from carbon monoxide. U.S. Pat. No. 3,643,452 to Ruhemann et al. discloses separating a light gas, such as hydrogen or helium, from a gas mixture that includes 90% or more by volume of the light gas. A stream of the hydrogen or helium is introduced into the gas centrifuge at a pressure and temperature just above its dew point. The stream passes through its dew point during centrifugation, forming liquid droplets of the hydrogen or helium, which are removed from the gas centrifuge and collected. Hydrogen is recovered from a gas mixture that includes hydrogen, nitrogen, argon, and methane, such as from a purge gas from a synthetic ammonia plant.

Many chemical reactions of industrial importance are limited because, typically, only a portion of the reactants is converted to products. In some cases, a kinetic limitation occurs and is overcome by allowing additional time for the reaction to occur or by adding a catalyst to increase the reaction rate. In other cases, the limitation is thermodynamic, caused by equilibrium. As the chemical reaction proceeds toward equilibrium, the presence of the products in a reaction mixture of the reactants and products causes a backward reaction that converts the products back into the reactants. At equilibrium, the rate of this backward reaction equals the rate of the forward reaction, producing no further net reaction and only partial conversion of the reactants to product. To increase the relative amount of the forward reaction compared to the backward reaction, a portion of the products is separated and removed from the reaction mixture or additional reactants are added to the reaction mixture. The reaction conditions, such as at least one of temperature and pressure, are altered to adjust the relative rates of the forward and back reactions. Changing the composition of the reaction mixture in one of these ways enables the forward chemical reaction to occur to a greater extent. Using or changing catalysts does not alter the relative amount of the forward and backward reactions, although it does alter the amount of time needed to reach equilibrium. The separation of the reactants and products is conducted in the same reactor as the chemical reaction, or is conducted in a second vessel. However, the separation utilizes additional equipment and, if conducted in the second vessel, often necessitates heating or cooling of the reaction mixture, which adds complexity and cost to the chemical reaction.

One potentially important set of chemical reactions is the sulfur-iodine (“S—I”) thermochemical water-splitting cycle (also known as the sulfur-iodine process), which is used to produce hydrogen and oxygen from water according to the following reactions:

2H₂O+SO₂+I₂→H₂SO₄+2HI (Reaction 1)

H₂SO₄→H₂O+SO₂+½O₂ (Reaction 2)

2HI [symbol] H₂+I₂ (Reaction 3)

As shown in Reaction 3, HI (hydriodic acid) is decomposed into H₂ (hydrogen) and I₂ (iodine). At the typical temperature and pressure conditions at which this cycle is conducted, only approximately 20% of the HI decomposes because this reaction is equilibrium limited. The need to recover and recycle the unreacted 80% of the HI means that the decomposition of HI accounts for 40% of the projected equipment costs of the S—I thermochemical water-splitting cycle. To separate the I₂ from the H₂ and unreacted HI, the H₂/I₂/HI reaction mixture is cooled so that the I₂ condenses, which creates large energy losses. The H₂ and I₂ are recovered and the I₂ is returned to Reaction 1. The SO₂ (sulfur dioxide) and H₂SO₄ (sulfuric acid) from Reactions 1 and 2 are also recovered and reused in the process, while the H₂ is used as a hydrogen source for a hydrogen-based economy.

A need exists to separate the unreacted HI so the HI may be recycled and greater amounts of the HI decomposed into H₂ and I₂. After the decomposition, it is also desirable to separate the H₂ from all the other mixture components so the H₂ can be obtained and sold as a pure product.

### BRIEF SUMMARY OF THE INVENTION

In one embodiment, the present invention includes a method of separating gaseous components. The method comprises conducting an equilibrium-limited, gas phase reaction in a first centrifugal separation device. At least a portion of a first product of the equilibrium-limited, gas phase reaction is separated in the first centrifugal separation device from a reaction mixture comprising at least one reactant and at least one product.

In another embodiment, the present invention includes a method of separating gaseous components. The method comprises introducing a gas mixture into a first centrifugal separation device and separating at least a portion of a first product from the gas mixture in the first centrifugal separation device. The gas mixture comprises at least one reactant and at least one product of an equilibrium-limited, gas phase reaction.

In yet another embodiment, the present invention includes a gas centrifuge comprising at least one rotor and a catalyst formulated to increase a rate of an equilibrium-limited, gas phase reaction.

In yet another embodiment, the present invention includes a gas cyclone comprising a catalyst formulated to increase a rate of an equilibrium-limited, gas phase reaction.

### BRIEF DESCRIPTION OF THE SEVERAL VIEWS OF THE DRAWINGS

While the specification concludes with claims particularly pointing out and distinctly claiming that which is regarded as the present invention, the advantages of this invention may be more readily ascertained from the following description of the invention when read in conjunction with the accompanying drawings in which:

FIG. 1 is a cross-sectional view of a gas centrifuge for separating gaseous components of an equilibrium-limited, gas phase reaction according to an embodiment of the invention;

FIG. 2 is a block diagram depicting a method of separating gaseous components of an equilibrium-limited, gas phase reaction according to an embodiment of the invention;

FIG. 3 is a cross-sectional view of a gas centrifuge for separating gaseous components of an equilibrium-limited, gas phase reaction according to an embodiment of the invention;

FIG. 4 is a block diagram depicting a method of separating gaseous components of an equilibrium-limited, gas phase reaction according to an embodiment of the invention;

FIG. 5 is a cross-sectional view of a gas centrifuge for separating gaseous components of an equilibrium-limited, gas phase reaction according to an embodiment of the invention;

FIG. 6 is a block diagram depicting a method of separating gaseous components of an equilibrium-limited, gas phase reaction according to an embodiment of the invention; and

FIG. 7 is a cross-sectional view of a gas centrifuge for separating gaseous components of an equilibrium-limited, gas phase reaction according to an embodiment of the invention.

### DETAILED DESCRIPTION OF THE INVENTION

A method of using a centrifugal separation device to separate gaseous components of an equilibrium-limited, gas phase reaction is disclosed. While using a gas centrifuge to separate the gaseous components is described herein, other centrifugal separation devices may be used, such as a gas cyclone. As used herein, the term “components” means and includes at least one reactant and at least one product of the equilibrium-limited, gas phase reaction. The reactants and products are defined as such relative to a forward reaction of the equilibrium-limited, gas phase reaction. While the equilibrium-limited, gas phase reaction may include at least one reactant or at least one product, for the sake of convenience, the plural terms “reactants” and “products” are used herein. As used herein, the term “gas phase reaction” means and includes a chemical reaction where the reactants and the products are in a gaseous phase or gaseous state. As used herein, the term “equilibrium-limited gas phase reaction” means and includes a chemical reaction conducted at conditions where a rate of the forward reaction equals or substantially equals a rate of a backward reaction, producing substantially no further net reaction.

The illustrations presented herein are not meant to be actual views of any particular gas centrifuge or gas centrifuge system, but are merely idealized representations which are employed to describe the present invention. Additionally, elements common between figures may retain the same numerical designation.

In one embodiment, the equilibrium-limited, gas phase reaction is conducted in a gas centrifuge and the gas centrifuge is used to separate the gaseous components of a reaction mixture produced by the gas phase reaction. The gas phase reaction and the separation may be conducted substantially simultaneously in the gas centrifuge. Since the reaction is equilibrium-limited, the reaction mixture includes the reactants and the products. To conduct the gas phase reaction, the reactants may be introduced to the gas centrifuge, which includes at least one rotor. The gas centrifuge may be maintained at temperature and pressure conditions sufficient for the gas phase reaction to occur. The reactants and products may be gaseous at the temperature and pressure conditions in the gas centrifuge. In another embodiment, the equilibrium-limited, gas phase reaction is conducted in a separate reactor or vessel operatively coupled to the gas centrifuge. The reaction mixture produced by the equilibrium-limited, gas phase reaction is transferred from the reactor to the gas centrifuge for separation.

The rotor of the gas centrifuge may be rotated at a speed sufficient to separate a desired product (referred to herein as a first product) from the other gaseous components of the reaction mixture. In one embodiment, the first product is hydrogen. During the separation, the gaseous components may remain in the gaseous phase by appropriately controlling the temperature and pressure conditions in the gas centrifuge. By way of non-limiting example, the temperature and pressure conditions for the gas phase reaction and for separation of the gaseous components may be substantially similar. The first product may be present in the reaction mixture at a relatively low concentration or may account for a large proportion of the reaction mixture.

A molecular weight of the first product may be sufficiently different from the molecular weights of the other gaseous components of the reaction mixture such that the first product is easily separated from the other gaseous components. By way of non-limiting example, the first product may have a molecular weight less than the molecular weights of the other gaseous components. For efficient separation, in one embodiment, the molecular weight of the first product is substantially less than the molecular weights of the other gaseous components and the molecular weight of the reactants is intermediate between that of the first product and the other products. However, the first product is not limited to having the lowest, relative, molecular weight. The molecular weight of the first product may be approximately equal to or greater than that of at least one of the other gaseous components, as long as the molecular weight difference between the first product and any other component in the reaction mixture is sufficient to achieve separation in the gas centrifuge. By way of non-limiting example, the molecular weight difference between the first product and any other component of the reaction mixture may be as little as approximately 3 amu.

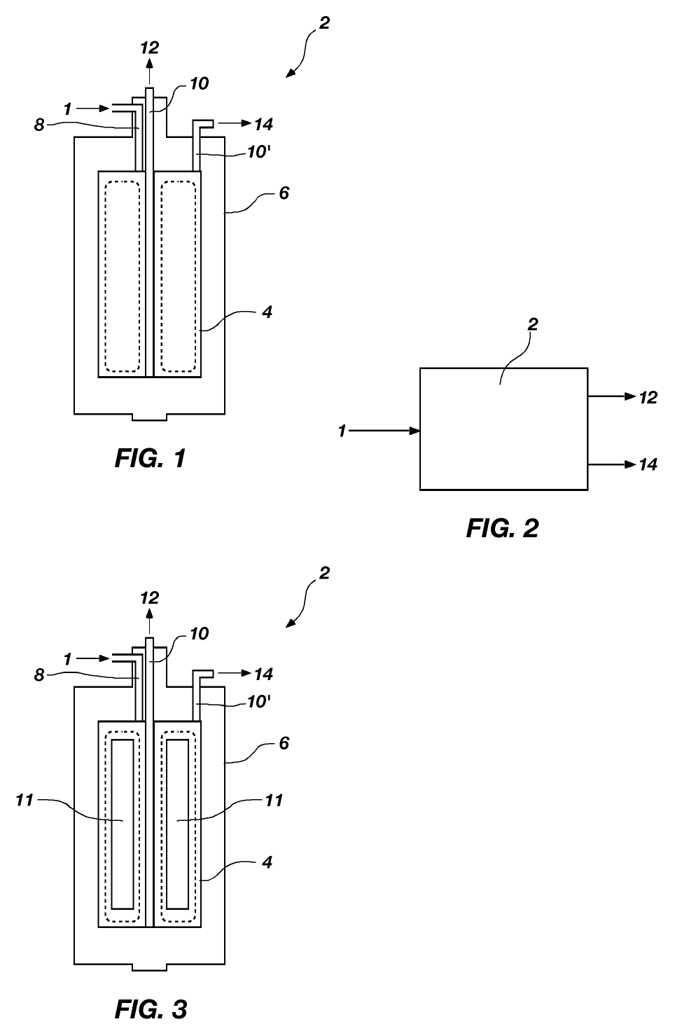

Gas centrifuges are known in the art and, therefore, are not described in detail herein. The gas centrifuge 2 may be a conventional device having rotor 4 surrounded by casing 6, as illustrated in FIG. 1. The gas centrifuge 2 and the rotor 4 may be selected based on the volume of the reaction mixture to be processed and a desired amount of the first product to be separated from the reaction mixture. By way of non-limiting example, the reaction mixture may be introduced into the gas centrifuge 2, or into a multistage system of gas centrifuges 2, at a rate of up to approximately 10 tons/hour. The gas centrifuge 2 may be of a sufficient size to process the desired volume of the reaction mixture and produce the desired amount of the first product. The rotor 4 may be of sufficient size to achieve the desired separation. The rotor 4 rotates at high speed in the casing 6 in a substantially friction-free environment. The separating capacity of the gas centrifuge 2 depends on the length of the rotor 4 and the rotor 4 wall speed and these parameters may be selected based on the molecular weight differences between the gaseous components in the reaction mixture to achieve the desired separating capacity. Operation of the gas centrifuge 2 is known in the art and, therefore, is not described in detail herein. As illustrated in FIGS. 1 and 2, the reactants 1 (or the reaction mixture 9 if the gas phase reaction is conducted in the separate reactor) may be introduced to the gas centrifuge 2 through at least one inlet 8 and separated gaseous components are removed from the gas centrifuge 2 through at least one outlet 10.

By way of non-limiting example, the gas centrifuge 2 may have a radius/length ratio of from approximately 0.02 to approximately 0.2. The rotor 4 may be formed from a material capable of withstanding the rotational loads, such as a lightweight, composite material including, but not limited to, Kevlar®, boron or carbon filaments. By way of non-limiting example, the speed of the rotor 4 may range from approximately 30,000 RPM to approximately 150,000 RPM. By way of non-limiting example, the rotor 4 may have a radius ranging from approximately 7 cm to approximately 9 cm. As known in the art, the gas centrifuge 2 also includes end caps, bearings or a suspension system, an electric motor and power supply, a center post, scoops, and baffles, which are not illustrated herein for sake of simplicity.

As illustrated in FIG. 3, the gas centrifuge 2 may, optionally, include a catalyst 11 to increase the rate of the gas phase reaction. A catalyst 11 may also be used if the centrifugal separation device is a gas cyclone. The catalyst 11 may be selected depending on the gas phase reaction to be performed. The reactants may be introduced into the gas centrifuge 2 and contacted with the catalyst 11 to produce the reaction mixture 9. The catalyst 11 may be coated on at least one internal surface of the gas centrifuge 2, such as on an internal surface of the rotor 4 of the gas centrifuge 2. The catalyst 11 may also be coated on internal fins oriented in the radial direction in the gas centrifuge 2 or on perforated cylindrical baffles coaxial with the rotor 4 of the gas centrifuge 2. Alternatively, a bed of the catalyst 11 may be incorporated into the rotor 4 of the gas centrifuge 2 or particles of the catalyst 11 may be located in the inlet 8 or on inner walls of the inlet 8. The bed of the catalyst 11 may be permeable to the gas mixture. The gas centrifuge 2 may, optionally, include a heat exchanger (not illustrated) to supply heat to or remove heat from the gas centrifuge 2 if the equilibrium-limited, gas phase reaction is endothermic or exothermic. If the centrifugal separation device is a gas cyclone, the catalyst 11 may be coated on at least one inner surface of the gas cyclone.

In use and operation, rotation of the rotor 4 applies centrifugal force to the reaction mixture 9, separating the gaseous components based on their respective molecular weights. Operation of gas centrifuges 2 is known in the art and, therefore, is not described in detail herein. By way of non-limiting example, the rotor 4 of the gas centrifuge 2 may be capable of rotating at a peripheral velocity of from approximately 350 m/s to approximately 1000 m/s. The rotor 4 in the gas centrifuge 2 may be maintained at temperature and pressure conditions sufficient for the components to remain gaseous during the separation. The centrifugal force causes at least one lower molecular weight component of the reaction mixture to move to the center of the rotor 4, while at least one higher molecular weight component moves to the periphery of the rotor 4. As such, centrifuging the reaction mixture 9 produces at least two gas streams in the rotor 4, a first gas stream 12 and a second gas stream 14. The first gas stream 12, which exits the gas centrifuge 2 at approximately the center of the rotor 4 through outlet 10, includes a greater concentration of the lower molecular weight component relative to the second gas stream 14. However, the lower molecular weight component may not account for 100% of the first gas stream 12 and may, in fact, be present in the first gas stream 12 at a relatively low concentration. Conversely, the second gas stream 14, which exits the gas centrifuge 2 at approximately the periphery of the rotor 4 through outlet 10′, includes a greater concentration of the higher molecular weight component relative to the first gas stream I₂. By removing at least a portion of the first product (by removing the first gas stream 12 from the reaction mixture 9), the reaction mixture 9 may be shifted from equilibrium. The second gas stream 14 may be further processed, as described below. However, the first gas stream 12 may also include substantially pure first product.

Assuming the first product has the lowest molecular weight of the gaseous components, the first gas stream 12 includes a greater concentration of the first product relative to the concentration of the first product in the reaction mixture 9 and the second gas stream 14 includes a greater concentration of the other gaseous components relative to the concentration of the other gaseous components in the reaction mixture 9. However, the first gas stream 12 may still include a relatively low concentration of the first product. Intermediate molecular weight component(s) may proportion into at least one of the first gas stream 12 and the second gas stream 14. The intermediate molecular weight component may be present in the first gas stream 12 and the second gas stream 14 in an amount intermediate between that of the first product in the first gas stream 12 and in the second gas stream 14.

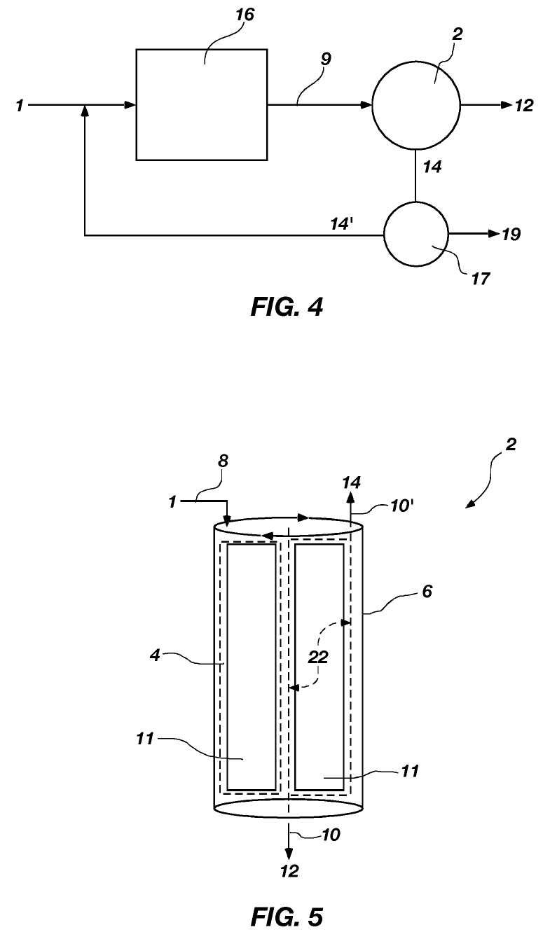

The equilibrium-limited, gas phase reaction may be conducted in a reactor 16 that is coupled to the gas centrifuge 2, as illustrated in FIG. 4. The reactants 1 are introduced into the reactor 16, which is maintained at sufficient temperature and pressure conditions for the gas phase reaction to occur, producing the reaction mixture 9. When equilibrium is approached or reached, the reaction mixture 9 may be transferred from the reactor 9 to the gas centrifuge 2 for separation of the gaseous components, as described above. Since the gas phase reaction is equilibrium-limited, the reaction mixture 9 includes the reactants and products. During the separation, the gas centrifuge 2 may be maintained at temperature and pressure conditions sufficient for the reactants and products to remain in the gaseous phase. In the gas centrifuge 2, the first product may be separated from the reaction mixture 9 and removed from the gas centrifuge 2 in the first gas stream I₂. The other gaseous components of the reaction mixture 9, which are present in the second gas stream 14, may, optionally, be further separated in separator 17. The second gas stream 14 may be introduced into the separator 17 so that at least a portion of a second product 19 is removed from the second gas stream 14 before returning or recycling the second gas stream 14′ to the reactor 16. The separator 17 may be an additional gas centrifuge 2, a condenser, a distillation column, or a membrane separator. The second gas stream 14′ may be introduced to the reactor 16. By removing at least a portion of the second product 19 from the second gas stream 14, the second gas stream 14′ entering the gas centrifuge 2 may be further from equilibrium, enabling further reaction of the reactants. In one embodiment, the first product is hydrogen, the second product 19 is I₂, and second gas stream 14, 14′ includes a mixture of HI and I₂. Alternatively, the second gas stream 14 may be returned to the reactor 16.

As illustrated in FIGS. 1 and 2, the first gas stream 12 may be removed from the gas centrifuge 2 through the outlet 10 located in proximity to the center of the rotor 4. The second gas stream 14 may be removed from the gas centrifuge 2 through the outlet 10′, which is located in proximity to the periphery of the rotor 4. While the outlets 10, 10′ are illustrated as being located on the same end of the gas centrifuge 2, the outlets 10, 10′ may be located on opposite ends of the gas centrifuge 2.

If the first product in the first gas stream 12 has a molecular weight substantially lower than that of the other gaseous components in the second gas stream 14, the first gas stream 12 may include the first product and the second gas stream 14 may include the other gaseous components, such as the reactants and the second product 19. In one embodiment, the first product accounts for substantially all of the volume of the first gas stream 12, such as greater than approximately 95% of the volume of the first gas stream I₂. To shift the reaction mixture 9 away from equilibrium, at least a portion of the first product may be removed from the reaction mixture 9 by removing at least a portion of the first gas stream 12 from the gas centrifuge 2. The first product may be present in the first stream 12 at least approximately 20% of the volume of the first product in the reaction mixture 9. In one embodiment, the volume of the first stream 12 includes greater than or equal to approximately 50% of the first product. The reactants may be present in the first stream 12 at less than approximately 20% of the volume of the reactants in the reaction mixture 9. In one embodiment, the volume of the first stream 12 includes less than or equal to approximately 10% of the reactants. Recovery and purity of the first product may depend on the configuration and operation of the gas centrifuge 2 or multistage system of gas centrifuges 2. By removing at least a portion of the first product from the reaction mixture 9 or removing the first product at higher concentrations in the first gas stream 12, additional thermodynamic separation may be conducted in the gas centrifuge 2. As such, the flow and concentration of the first gas stream 2 may vary depending on the economically optimum conditions for the process at hand.

The first gas stream 12, including the first product, may be utilized in numerous commercial processes, such as for producing hydrogen gas for use in the hydrogen-based economy. The first gas stream 12 may also be further processed, as described below, if higher purity of the first product is desired. The second gas stream 14, including the reactants and other products (other gaseous components), may be further processed, as described below. Additional processing of the second gas stream 14 may remove any remaining first product or may provide the second gas stream 14 as a source of additional reactants for the equilibrium-limited, gas phase reaction.

The gas centrifuge 2 may be operated in a so-called “batch” mode or in a so-called “continuous” mode. In batch mode, the reactants 1, first gas stream 12, and second gas stream 14 may be intermittently introduced to and intermittently removed from the gas centrifuge 2. In continuous mode, the reactants 1, first gas stream 12, and second gas stream 14 may be continuously introduced to and continuously removed from the gas centrifuge 2. In one embodiment, the gas centrifuge 2 is operated in the continuous mode, providing steady flows of the reactants 1, first gas stream 12, and second gas stream 14 into and out of the gas centrifuge 2.

If the reaction mixture 9 includes at least one component having an intermediate molecular weight, the intermediate molecular weight component 22 may accumulate in a middle position of the rotor 4 relative to the position of the other components in the rotor 4, as illustrated in FIG. 5. However, at steady state, the intermediate molecular weight component 22 may distribute or proportion into the first gas stream 12 or into the second gas stream 14 during the separation, as indicated by dashed lines leading from intermediate molecular weight component 22 in FIG. 5. Since the middle position of the rotor has a lower concentration of the other gaseous components of the reaction mixture 9 than the first gas stream 12 and the first gas stream 14, and since the first gas stream 12 and the first gas stream 14 exit the gas centrifuge 2, the gas phase reaction in the gas centrifuge 2 is not at thermodynamic equilibrium. The continual addition of the reactants and removal of the first gas stream 12 (including the first product) and the second gas stream 14 enables the reaction mixture 9 to be at a steady state condition even though the reaction mixture 9 is not at thermodynamic equilibrium. If the intermediate molecular weight component 22 accumulates in the middle position of the rotor 4, the intermediate molecular weight component 22 may be selectively proportioned into the first gas stream 12 or into the second gas stream 14 by removing a portion of the respective gas stream into which the intermediate molecular weight component 22 is desired to be proportioned. By way of non-limiting example, if the first gas stream 12 includes the first product, a portion of the second gas stream 14 may be removed from the gas centrifuge 2 to proportion the intermediate molecular weight component 22 into the second gas stream I₂. As such, the first gas stream 12 may be substantially free of the intermediate molecular weight component 22. Whichever of the first gas stream 12 or the second gas stream 14 is selected to include the intermediate molecular weight component 22 (or both the first gas stream 12 and the second gas stream 14 if the intermediate molecular weight component 22 proportions into both streams) may be further reacted since the reaction mixture 9 is no longer at equilibrium.

Depending on the separation factor between the first product and the other gaseous components of the reaction mixture 9, the first gas stream 12 may include a small concentration of the other gaseous components, such as of the reactants and other products. By way of non-limiting example, the concentration of the other gaseous components in the first gas stream 12 may range from zero to the concentration of the other gaseous components in the reaction mixture 9 introduced into the gas centrifuge 2. Conversely, the second gas stream 14 may include a small concentration of the first product. By way of non-limiting example, the concentration of the first product in the second gas stream 14 may range from zero to the concentration of the first product in the reaction mixture 9 introduced into the gas centrifuge 2. The separation factor may depend on the difference in molecular weight between the first product and the other gaseous components and on the number of concentration stages performed in the gas centrifuge 2. If the first product has a substantially different molecular weight than the other gaseous components of the reaction mixture 9, a substantially pure first product may be obtained after one stage or cycle in the gas centrifuge 2. If, however, the first product has a similar molecular weight to at least one of the other gaseous components of the reaction mixture 9, additional stages or cycles through the gas centrifuge 2 or through multiple gas centrifuges 2 may be used to obtain the desired purity of the first product.

By conducting the gas phase reaction and separation of the gaseous components substantially simultaneously, the equilibrium limitations of the gas phase reaction may be bypassed. In addition, by utilizing the gas centrifuge 2 for both the reaction and the separation, the complexity and amount of equipment used to produce substantially pure first product may be reduced.

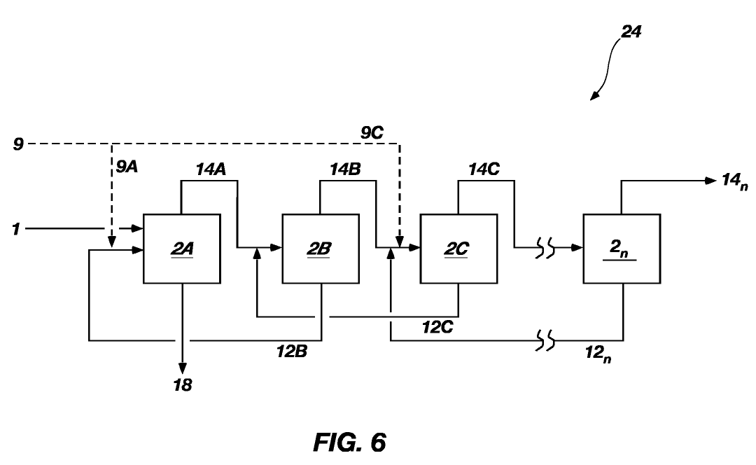

To improve the efficiency of the separation and the purity of the first product, the first gas stream 12 and the second gas stream 14 may be passed through a multistage system 24 of gas centrifuges 2, as illustrated in FIG. 6. Multiple concentration stages may be conducted using a train or cascade of gas centrifuges 2 to achieve the desired purity of the first product. The first product may be recovered from the first gas streams 12 exiting the gas centrifuges 2. The first gas steams 2 of each of the gas centrifuges 2 may be transferred to additional gas centrifuges 2 until the first product is at the desired purity. The number of stages utilized to achieve the desired purity depends on the separation factor, which depends on the difference in molecular weight between the first product and the other gaseous components.

In the multistage system 24, a plurality of gas centrifuges 2 may be operatively coupled together in series to form the cascade, as illustrated in FIG. 6. However, the plurality of gas centrifuges 2 may also be operatively coupled together in parallel. In addition, a plurality of multistage systems 24 may be operatively coupled together in parallel to achieve greater throughput. The multistage system 24 may include any number of gas centrifuges 2 to achieve the desired purity of the first product 18. The number of gas centrifuges 2 in the multistage system 24 is described herein as “n” and may be any integer greater than or equal to 2. A first gas centrifuge 2A may be used to conduct the gas phase reaction, producing the reaction mixture 9 from the reactants 1, or the reaction mixture 9 (shown by the dashed line in FIG. 6) may be introduced into the first gas centrifuge 2A from the reactor 16 (not shown in FIG. 6). The reaction mixture 9 may alternatively be introduced into at least one of the plurality of gas centrifuges 2 in the cascade, as illustrated in FIG. 6 by reaction mixture 9C fed to gas centrifuge 2C. The location for introducing the reaction mixture 9 into at least one of the plurality of gas centrifuges 2 may be selected to maximize separation performance of the multistage system 24.

The first gas centrifuge 2A may also be used to separate the first product 18 and other gaseous components 20 from the reaction mixture 9. The second gas stream 14A may be removed from the first gas centrifuge 2A and introduced to a second gas centrifuge 2B. The first gas stream 12B from the second gas centrifuge 2B may be introduced to additional gas centrifuges 2 for further purification and concentration of the first product 18. The first gas stream 12B exiting the second gas centrifuge 2B may include the first product 18 at a higher concentration than the first gas stream 12 exiting a subsequent gas centrifuge, such as gas centrifuge 2C through 2ₙ The second gas stream 14B exiting from the second gas centrifuge 2B may be introduced to a third gas centrifuge 2C (i.e., a subsequent gas centrifuge (2D, 2E, . . . 2ₙ)), while the first gas stream 12B exiting from the second gas centrifuge 2B may be returned to the first gas centrifuge 2A (or a previous gas centrifuge (2ₙ₋₁, . . . 2C, 2B)). The first gas stream 12 may exit the first gas centrifuge 2A as first product 18. As such, the feed into a specific gas centrifuge 2 includes the second gas stream 14 from the previous gas centrifuge and the first gas stream 12 from the subsequent gas centrifuge. This process may be repeated until the first product 18 having the desired purity is achieved and removed from the first gas centrifuge 2A. The second gas stream 14, exiting the last gas centrifuge 2ₙ is removed from the multistage system 24. As the first gas streams 12 from each of the gas centrifuges 2 progress through the multistage system 24, the first product 18 becomes more concentrated in the first gas streams I₂. After passing through the plurality of gas centrifuges 2 of the multistage system 24, the first product 18 may be substantially pure, such as approximately 95% pure. Similarly, as the second gas streams 14 from each of the gas centrifuges 2 progress through the multistage system 24, the first product 18 becomes less concentrated in the second gas streams 14. By way of non-limiting example, the second gas stream 14ₙ exiting the final gas centrifuge 2ₙ may include the first product 18 at a purity of approximately 5%.

By recycling the second gas stream 14, which includes unreacted reactants, to additional gas centrifuges 2, overall conversion of the reactants to the products may be increased. In addition, by using the gas centrifuge 2 to separate the first product 18 from other gaseous components 20 in the reaction mixture 9, a condenser or distillation column may not be utilized to shift the equilibrium of the reaction mixture 9 (by removing the first product 18) before recycling the second gas stream 14. As such, heat and energy losses associated with the condenser or distillation column may be minimized.

In addition to the multistage system 24 of gas centrifuges 2, a plurality of reactors 16 may be used in combination with a plurality of gas centrifuges 2 to conduct the equilibrium-limited, gas phase reaction and separation of the gaseous components of the reaction mixture 9.

The gas centrifuge 2, or multistage system 24 of gas centrifuges 2, may be used to separate the first product 18 from the other gaseous components 20 of any equilibrium-limited, gas phase reaction, such as to separate hydrogen (i.e., the first product 18) from the other gaseous components 20 of an equilibrium-limited, gas phase reaction that produces hydrogen. Since hydrogen has a lower molecular weight than most compounds and has a high diffusivity, the hydrogen may be easily separated from the other gaseous components 20 of such hydrogen-producing reactions. In gas phase reactions that utilize helium as a diluent or carrier gas, the helium may be separated in a similar manner. The gas centrifuge 2 or multistage system 24 of gas centrifuges 2 may also be used to separate gaseous components of other equilibrium-limited, gas phase reactions, such as those that produce an alcohol, ether, or ester. By way of non-limiting example, the gas centrifuge 2 or multistage system 24 of gas centrifuges 2 may be used to separate hydrogen or an alcohol, ether, or ester produced by one of the following reactions:

S—I thermochemical water-splitting reaction:

2HI [symbol] H₂+I₂ (Reaction 3),

Water gas shift reaction:

CO+H₂O [symbol] CO₂+H₂ (Reaction 4),

Methanol synthesis reaction:

2H₂+CO [symbol] CH₃OH (Reaction 5),

Ammonia synthesis/decomposition reaction:

N₂+3H₂ [symbol] 2NH₃ (Reaction 6),

Ester formation/hydrolysis reaction:

ROH+R′COOH [symbol] R′COOR+H₂O (Reaction 7), and

Ether formation/hydrolysis reaction:

ROH+R′OH [symbol] ROR′+H₂O (Reaction 8),

where R and R′ are alkyl or aryl groups. The alkyl groups may be straight or branched chain alkyl groups. R and R′ may be independently selected such that R and R′ are the same or are different. While the above-mentioned Reactions include one or two reactants and one or two products, the equilibrium-limited, gas phase reaction may have more than two reactants and more than two products. The equilibrium-limited, gas phase reaction may also be the combination of at least two different, equilibrium, gas phase reactions conducted in the same reactor to produce an overall net equilibrium-limited, gas phase reaction.

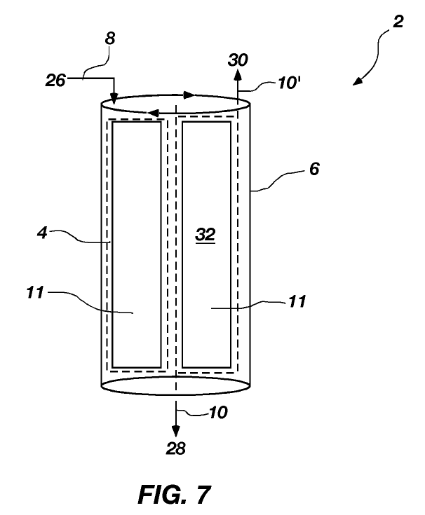

In one embodiment, the gas centrifuge 2 may be used to decompose HI into H₂ and I₂, according to Reaction 3, and to separate the H₂ from the I₂ and HI. As illustrated in FIG. 7, the HI 26 may be introduced into the gas centrifuge 2 and the gas centrifuge 2 may be maintained at temperature and pressure conditions sufficient for the decomposition reaction to occur. The gas centrifuge 2 may be maintained at a temperature within a range of from approximately 200° C. to approximately 750° C., such as from approximately 300° C. to approximately 700° C. The pressure in the gas centrifuge 2 may be maintained within a range of from approximately 1 bar to approximately 300 bars, such as from approximately 20 bars to approximately 250 bars. By way of non-limiting example, the gas centrifuge 2 may be maintained at a temperature of approximately 200° C. and a pressure of approximately 100 psi during the reaction and separation. The gas centrifuge 2 may, optionally, include the catalyst 11 to catalyze the decomposition reaction. By way of non-limiting example, the catalyst 11 may be a carbon-containing material, such as activated carbon. If present, a bed of the catalyst 11 may be located in the gas centrifuge 2 or a coating or layer of the catalyst 11 may be applied to at least one inner surface of the gas centrifuge 2. Upon contact with the catalyst 11, the HI 26 may begin to decompose into H₂ and I₂. Alternatively, the HI 26 may be decomposed into H₂ and I₂ in a separate reactor 16, which is operably coupled to the gas centrifuge 2. Once equilibrium is reached, the reaction mixture 9 of the H₁, H₂, and I₂ may be transferred to the gas centrifuge 2 and the H₂ separated from the I₂ and HI, as described below.

H₂, I₂, and HI have significantly different molecular weights (2.01 amu, 253.8 amu, and 127.9 amu, respectively). The centrifugal force produced by the rotor 4 causes the H₂ 28 to separate from the I₂ 30 and HI 32, with the H₂ 28 moving to the center of the rotor 4 and the I₂ 30 moving to the periphery of the rotor 4. Since the H₂ 28 has a lower molecular weight than that of the I₂ 30 and HI 32, the first gas stream 12 includes at least H₂ 28 and the second gas stream 14 includes at least I₂ 30. Since the molecular weight of the HI 32 is intermediate that of the H₂ 28 and I₂ 30, the HI 32 may proportion into the first gas stream 12, into the second gas stream 14, into both the first gas stream 12 and the second gas stream 14, or may accumulate in the middle portion of the rotor 4. As such, the first gas stream 12 may include H₂ or a mixture of H₂ and HI and the second gas stream 14 may include I₂ or a mixture of I₂ and HI.

As the HI 32 accumulates in the middle position of the rotor 4 and the H₂ 28 and I₂ 30 are removed from the gas centrifuge 2, the HI decomposition reaction is no longer equilibrium limited because the reaction mixture 9 includes an increased concentration of the reactant (HI 32) and a decreased concentration of the products (H₂ 28 and I₂ 30). As such, the HI 32 in the middle position of the rotor 4 may decompose. Removing the H₂ 28 and I₂ 30 from the reaction mixture 9 enables more HI 32 to decompose than if the H₂ 28 and I₂ 30 were not separated from the reaction mixture 9. By integrating the reaction and separation, the equilibrium limitation is avoided. As the HI 32 accumulates in the middle portion of the rotor 4, the HI 32 may be selectively proportioned into the second gas stream 14 including the I₂ 30 by removing a desired percentage of the second gas stream 14 from the gas centrifuge 2. As such, the first gas stream 12 may include substantially pure H₂ 28. The H₂ 28 recovered from the gas centrifuge 2 may be any desired purity depending on the configuration of the gas centrifuge 2 or of the multistage system 24 of gas centrifuges 2. The H₂ 28 may be used in other processes, such as a H₂ source for the hydrogen-based economy. The I₂ 30 may be recycled and reused as a reactant in Reaction 1 of the S—I thermochemical water-splitting cycle. The HI 32 may be recycled and reused as a reactant in Reaction 3 of the S—I thermochemical water-splitting cycle.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

What is claimed is:

1. A method of separating gaseous components, comprising:
conducting an equilibrium-limited, gas phase reaction in a first centrifugal separation device; and
separating at least a portion of a first product of the equilibrium-limited, gas phase reaction from a reaction mixture comprising at least one reactant and at least one product in the first centrifugal separation device.

2. The method of claim 1, wherein conducting an equilibrium-limited, gas phase reaction in a first centrifugal separation device comprises producing hydrogen.

3. The method of claim 1, wherein conducting an equilibrium-limited, gas phase reaction in a first centrifugal separation device comprises decomposing hydriodic acid into hydrogen and iodine.

4. The method of claim 1, wherein separating at least a portion of a first product of the equilibrium-limited, gas phase reaction from a reaction mixture comprising at least one reactant and at least one product in the first centrifugal separation device comprises separating at least a portion of hydrogen from the reaction mixture.

5. The method of claim 1, wherein conducting an equilibrium-limited, gas phase reaction in a first centrifugal separation device and separating at least a portion of a first product of the equilibrium-limited, gas phase reaction from a reaction mixture comprising at least one reactant and at least one product in the first centrifugal separation device comprises substantially simultaneously reacting the at least one reactant to produce the at least one product and separating the at least a portion of the first product from the reaction mixture.

6. The method of claim 1, wherein conducting an equilibrium-limited, gas phase reaction in a first centrifugal separation device comprises conducting the equilibrium-limited, gas phase reaction in a first gas centrifuge.

7. The method of claim 1, wherein separating at least a portion of a first product of the equilibrium-limited, gas phase reaction from a reaction mixture comprising at least one reactant and at least one product in the first centrifugal separation device comprises separating at least a portion of the first product from the reaction mixture substantially at equilibrium.

8. The method of claim 1, further comprising incorporating a catalyst into the first centrifugal separation device.

9. The method of claim 8, wherein incorporating a catalyst into the first centrifugal separation device comprises incorporating a bed of the catalyst into the first centrifugal separation device, coating an internal surface of the first centrifugal separation device with the catalyst, or incorporating particles of the catalyst in an inlet of the first centrifugal separation device.

10. The method of claim 1, further comprising transferring the first product to at least one other centrifugal separation device for further purification of the first product.

11. The method of claim 1, further comprising transferring the reaction mixture to at least one other centrifugal separation device for further purification of the first product.

12. A method of separating gaseous components, comprising:
introducing a gas mixture into a first centrifugal separation device, the gas mixture comprising at least one reactant and at least one product of an equilibrium-limited, gas phase reaction; and
separating at least a portion of a first product from the gas mixture in the first centrifugal separation device.

13. The method of claim 12, wherein introducing a gas mixture into a first centrifugal separation device comprises introducing the gas mixture into a first gas centrifuge.

14. The method of claim 12, wherein introducing a gas mixture into a first centrifugal separation device comprises introducing the gas mixture comprising hydrogen, iodine, and hydriodic acid.

15. The method of claim 12, wherein separating at least a portion of a first product from the gas mixture in the first centrifugal separation device comprises separating at least a portion of hydrogen from the gas mixture comprising iodine and hydriodic acid.

16. The method of claim 12, wherein introducing a gas mixture into a first centrifugal separation device comprises introducing a gas mixture comprising hydrogen, iodine, and hydriodic acid; carbon monoxide, water, carbon dioxide, and hydrogen; hydrogen, carbon monoxide, and methanol; hydrogen, nitrogen, and ammonia; at least one alcohol, water, and an ester; or at least one alcohol, water, and an ether.

17. The method of claim 12, wherein separating at least a portion of a first product from the gas mixture in the first centrifugal separation device comprises separating at least a portion of a gas having a low molecular weight relative to the molecular weight of other gases in the gas mixture.

18. The method of claim 12, further comprising transferring the first product to at least one other centrifugal separation device for further purification of the first product.

19. The method of claim 12, further comprising transferring the gas mixture to at least one other centrifugal separation device for further purification of the first product.

20. A gas centrifuge, comprising:
at least one rotor and a catalyst, the catalyst formulated to increase a rate of an equilibrium-limited, gas phase reaction.

21. The gas centrifuge of claim 20, wherein the catalyst comprises a permeable bed in the at least one rotor, a coating on an internal surface of the at least one rotor, or particles located in an inlet of the gas centrifuge.

22. A gas cyclone comprising a catalyst, the catalyst formulated to increase a rate of an equilibrium-limited, gas phase reaction.

23. The gas cyclone of claim 22, wherein the catalyst is coated on at least one inner surface of the gas cyclone.
